(19) United States
(12) Patent Application Publication
(10) Pub. No.: US 2004/0063470 A1
(43) Pub. Date: Apr. 1, 2004

(54) Rapid dialing apparatus and method thereof

(76) Inventors: Zhi Yun Zhang, Shanghai City (CN); Tony Tsai, Taipei City (TW)

Correspondence Address: BIRCH STEWART KOLASCH & BIRCH, PO BOX 747, FALLS CHURCH, VA, 22040-0747, US

(21) Appl. No.: 10/255,826

(22) Filed: Sep. 27, 2002

(51) Int. Cl. H04B 1/38

(52) U.S. Cl. 455/564; 455/460

(57) ABSTRACT

A method and apparatus for rapid dialing of a mobile terminal. A database is set in a memory unit of the mobile terminal, including mobile service provider data and at least one corresponding Internet phone prefix code. A mobile service provider is selected from the database to obtain the corresponding Internet phone prefix code. A destination number is entered by an input device to combine with the Internet phone prefix code resulting in a final complete character string, which is then dialed.

### FIELD OF THE INVENTION

The invention relates to an apparatus for rapid dialing of an Internet phone (IP) and, more particularly, to rapid dialing of the Internet phone based on mobile service provider with corresponding Internet prefix code and a preset destination number.

### BACKGROUND OF THE INVENTION

Internet phone (I-phone, IP) as implied by the name, transmits voice over the Internet, similar to a conventional telephone.

Placing an international call by Internet phone costs only local call charges, saving use costs considerably.

Users maintainternet access at the same time and use the same software when communicating by Internet phone.

An analog voice signal is digitized for transport by the Internet phone in packets from a sending computer to a receiving computer, wherein the digitized voice signal is restored to analog from.

Both computers have hardware, for example, a sound card, amplifier, microphone, cable modem, ADSL (Asymmetric Digital Subscriber Line), or dial-up account with a modem respectively.

The calling cost of the Internet phone is very low excluding the hardware.

Mobile phones are a popular communication tool, and users can dial anywhere via the mobile phone's wireless capability. Mobile service providers provide Internet phone service to attract users.

Internet phone use consists of keying an Internet prefix code corresponding to a mobile service provider for the mobile phone, keying in a destination number of the mobile phone, and dialing the complete number, combined with the Internet prefix code and the destination number.

Operation of the Internet phone is inconvenient and slow.

Moreover, if the destination numbers are combined with the Internet prefix code corresponding to the mobile service provider, the size of the memory unit of the mobile phone will be compromised.

### SUMMARY OF THE INVENTION

The present invention is directed to a method and apparatus for reducing dialing time when the mobile service provider is changed.

Accordingly, the present invention provides a method for rapid dialing, comprising the steps of setting a database in a memory unit of the mobile terminal which includes mobile service provider data and at least one corresponding Internet phone prefix code, selecting a mobile service provider from the database to obtain the corresponding Internet phone prefix code; inputting a destination number to combine with the Internet phone prefix code resulting in a final complete character string; and dialing the final complete character string.

Accordingly, the present invention provides a rapid dialing apparatus comprising an input device for inputting data, a database for storing mobile service provider data and an Internet phone prefix code entered by the input device. The Internet phone prefix code corresponds to the mobile service provider data, and a search device selects mobile service provider data from the database to obtain an Internet phone prefix code. A registry temporarily stores the Internet phone prefix code and a selected destination number, and a auto-combining number device combines the destination number with the Internet phone prefix code.

### BRIEF DESCRIPTION OF THE DRAWINGS

For a better understanding of the present invention, reference is made to a detailed description to be read in conjunction with the accompanying drawings, in which:

FIG. 1 is a block diagram of the present invention;

FIG. 2 is a flowchart of the method of the present invention;

FIG. 3 shows the rapid dialing apparatus of the present invention; and

FIG. 4 is a flowchart of perfroming an auto-dial process of the present invention.

### DETAILED DESCRIPTION OF THE INVENTION

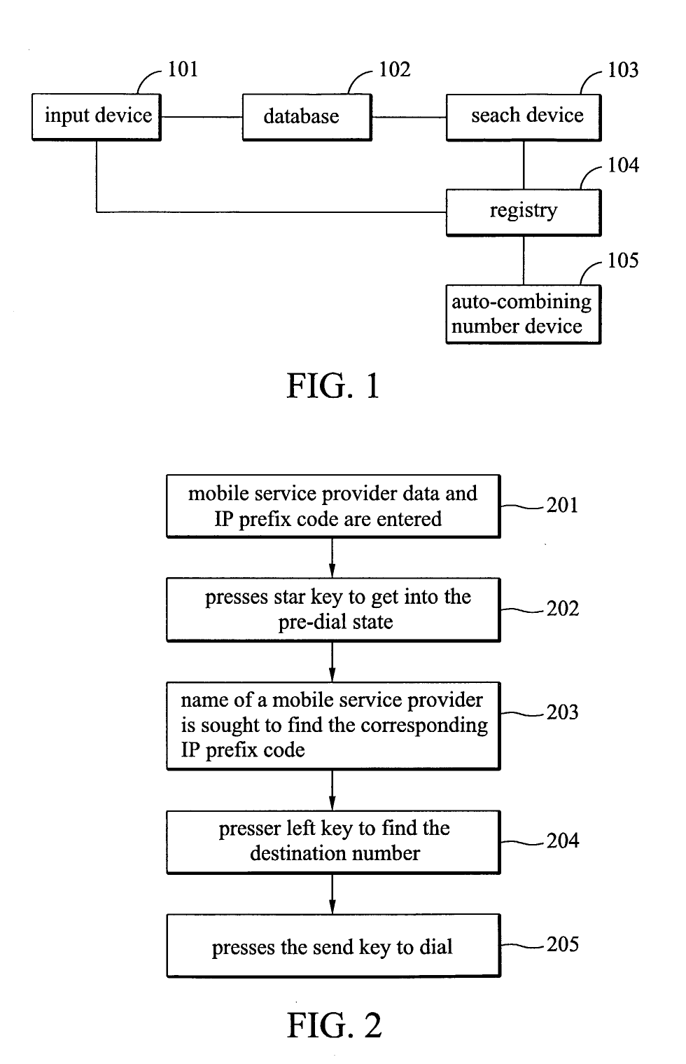

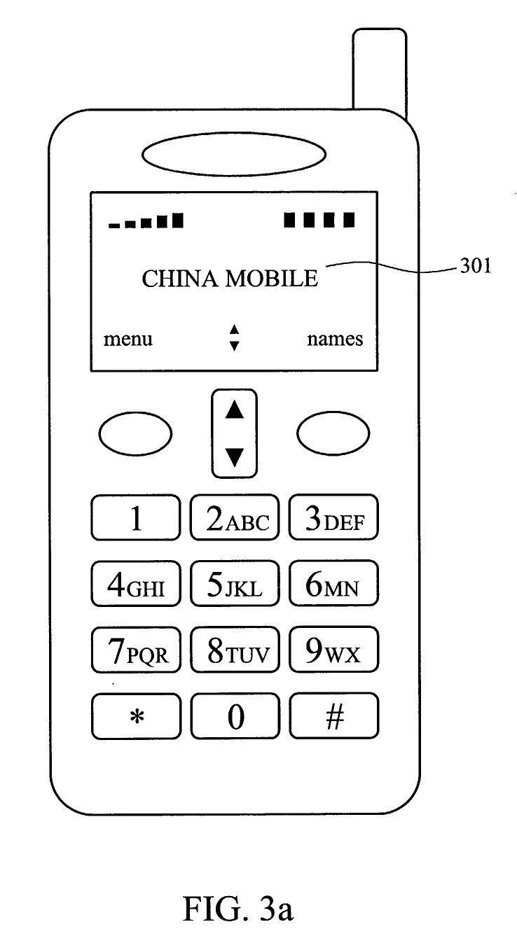

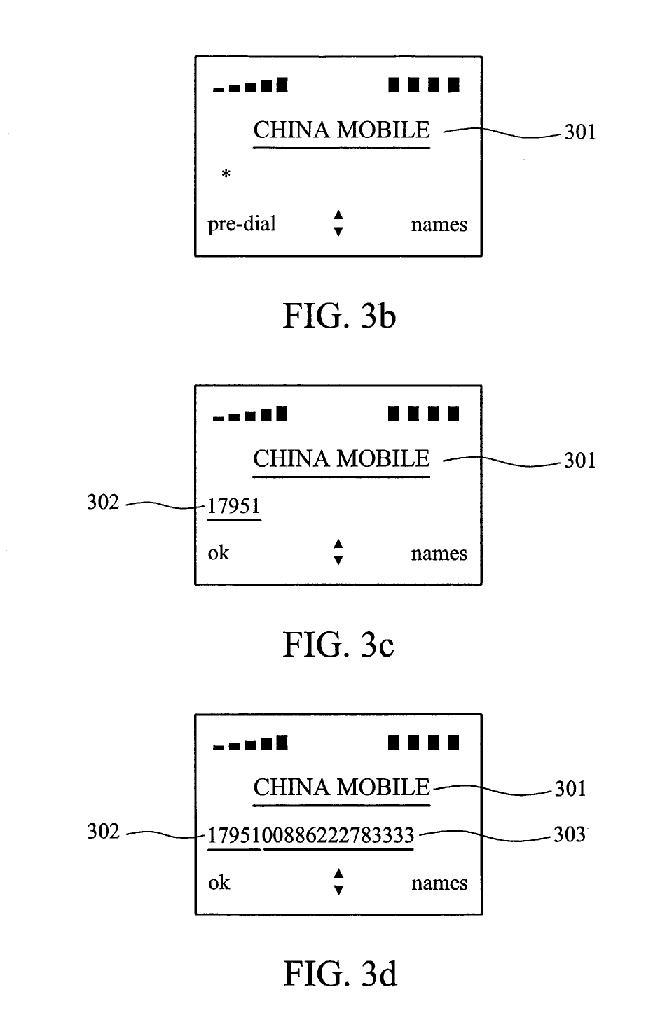

FIG. 1 is a block diagram of the rapid dialing apparatus of the present invention, FIG. 2 is a flowchart of the method of the present invention, and FIG. 3 shows a rapid dialing apparatus of the present invention.

In step 201, first, mobile service provider data and at least one Internet phone prefix code are entered into the mobile phone by means of an input device 101, and saved in a database 102 of a memory unit. Thus, a mobile service provider and Internet phone prefix code list is set up.

In step 202, the name of the mobile service provider in the database 102 is sought by a search device 103 to find the corresponding Internet phone prefix code.

The corresponding Internet prefix code is temporarily saved in a registry 104 and shown in a display of the mobile phone.

In FIG. 3a, the mobile phone is operating under a Mobile communications System named China Mobile, and the words China Mobile are shown on the display.

In FIG. 3b, when a user presses a key, for example the star key, to dial, the key is shown on the display.

In step 203, the user presses another key, for example the left key, and the mobile service provider and Internet phone prefix code list are shown on the display.

A corresponding Internet prefix code 302 is shown on the display when the user selects a mobile service provider from the mobile service provider and Internet phone prefix code list.

In FIG. 3c, the Internet prefix code 302 represents a numeral, 17951, when the mobile service provider selected from the mobile service provider and Internet phone prefix code list is China Mobile.

In step 204, the user presses another key, for example the right key, and a phone book appears on the display. When a destination number 303 is selected from in the mobile phone's phone book, the destination number 303 is auto-combined with the Internet prefix code 302 by an auto-combining number device 105.

In FIG. 3d, the destination number 303 generates a phone number, 00886222783333, which is then auto-combined with the numeral, 17951, resulting in a final complete character string, 1795100886222783333.

In step 205, the final complete character string, 1795100886222783333, combining the Internet prefix code 302 and the destination number tagged with 303 is dialed.

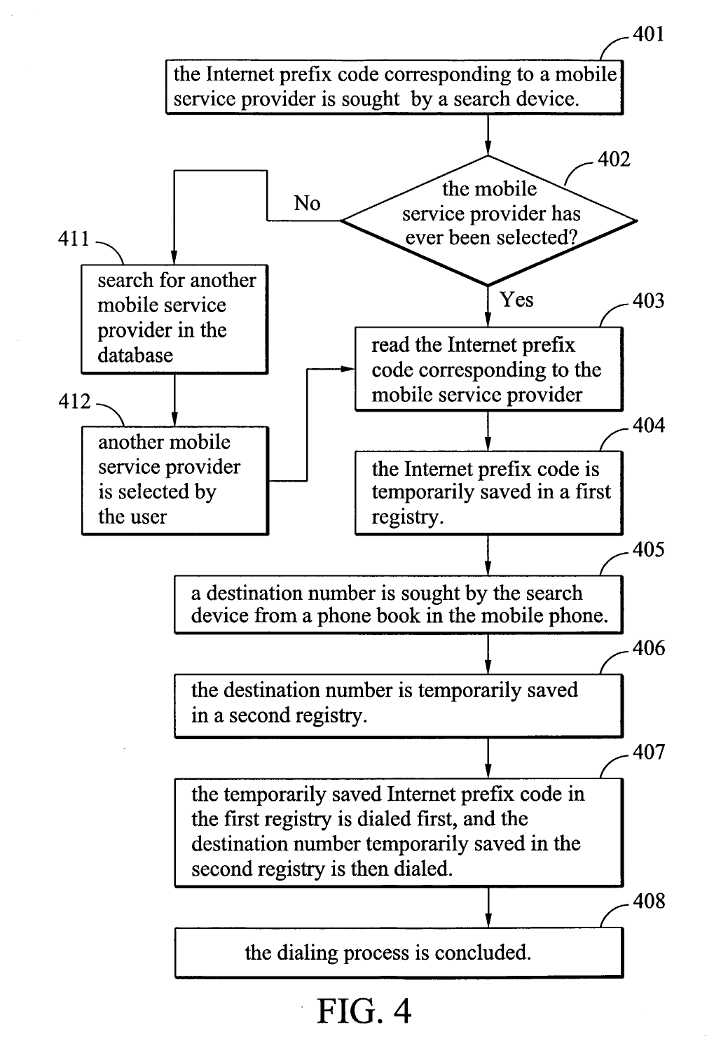

FIG. 4 is a flowchart of auto-dial process of the present invention.

In this case, the mobile service provider and corresponding Internet prefix code are saved in a database in a memory unit of the mobile phone, and at least one destination number is saved in the mobile phone's phone book in advance.

In step 401, the Internet prefix code corresponding to a mobile service provider is sought in the database of the mobile phone by a search device.

Step 402 checks whether the mobile service provider has ever been selected, and the corresponding Internet prefix code is temporarily saved in a memory unit. The mobile service provider selected is checked as to whether it was saved last time.

If, the method goes to step 403 to read the Internet prefix code corresponding to the mobile service provider.

If not, the method goes to step 411 to search for another mobile service provider in the database.

In step 412, another mobile service provider is selected by the user, and the method goes to step 403 to read the Internet prefix code corresponding to the selected mobile service provider.

In step 404, the Internet prefix code selected or input by the user is temporarily saved in a first registry.

In step 405, a destination number is sought by the search device from a phone book in the mobile phone.

In step 406, the destination number selected or directly input by the user is temporarily saved in a second registry.

In step 407, the temporarily saved Internet prefix code in the first registry is dialed first, and the destination number temporarily saved in the second registry is then dialed.

In step 408, the dialing process is concluded.

While the invention has been described by way of example and in terms of the preferred embodiment, it is to be understood that the invention is not limited to the disclosed embodiment. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A method for rapid dialing of a mobile terminal, comprising:
setting a database in a memory unit of the mobile terminal which includes mobile service provider data and at least one corresponding Internet phone prefix code;
selecting a mobile service provider from the database to obtain the corresponding Internet phone prefix code;
input of a destination number by an input device to combine with the Internet phone prefix code resulting in a final complete character string; and
dialing the final complete character string.

2. A rapid dialing apparatus, comprising:
an input device for inputting data;
a database for storing mobile service provider data and corresponding Internet phone prefix code data entered by the input device;
a search device for selecting mobile service provider data from the database to obtain an Internet phone prefix code;
a registry for temporary storing the Internet phone prefix code and a selected destination number; and an auto-combining number device for combining the destination number with the Internet phone prefix code.

3. The rapid dialing apparatus of claim 2, wherein the input device is a keyboard.

4. The rapid dialing apparatus of claim 2, wherein the input device is an electrical device, inputting data through a transmission line.

5. The rapid dialing apparatus of claim 4, wherein the electronic device is a PDA or PC.
